(19) United States
(12) Patent Application Publication
(10) Pub. No.: US 2004/0044632 A1
(43) Pub. Date: Mar. 4, 2004

(54) Automated closed banking system

(76) Inventors: Liav Onn, Tel-Aviv (IL); Sharon Onn, Rishon-Lezion (IL)

Correspondence Address: DANIEL J SWIRSKY, PO BOX 2345, BEIT SHEMESH, 99544, IL

(21) Appl. No.: 10/270,730

(22) Filed: Oct. 16, 2002

Related U.S. Application Data
(60) Provisional application No. 60/406,960, filed on Aug. 30, 2002.

(51) Int. Cl. H04K 1/00; G06F 17/60

(52) U.S. Cl. 705/67

(57) ABSTRACT

A banking method including receiving an authorization from a customer to transfer funds belonging to the customer from a source financial institution as part of a closed banking transaction, where the receiving includes receiving the authorization separate from any instruction to transfer funds, providing at least one closed banking deposit option to the customer via a communications device for selection thereat, receiving a deposit option selection from the communications device, and transferring funds from the source financial institution in accordance with the deposit option selection, where the transferring includes effecting the transfer via an interbank clearing entity without requiring a specific approval from the source financial institution for the transfer.

### CROSS REFERENCE TO RELATED APPLICATIONS

This application claims priority under 35 U.S.C. §119(e) to U.S. Provisional Patent Application No. 60/406,960, filed on Aug. 30, 2002, titled “Banking System,” and incorporated herein by reference in its entirety.

### FIELD OF THE INVENTION

The present invention relates to banking systems in general, and more particularly to systems and methods for transferring funds between banks.

### BACKGROUND OF THE INVENTION

In classic retail banking, a customer opens an account with a particular financial institution A, such as a bank, into which the customer deposits funds and for which the customer usually receives interest. A customer wishing to take advantage of a higher interest rate at a different financial institution B must open an account at financial institution B and then transfer some or all of the funds from financial institution A to financial institution B. Opening a “stand-alone” account in this manner—an account from or through which it is possible to withdraw funds, either directly or via a transfer order to any other account in the banking system—requires adherence to a minimal set of banking standards. Such standards typically require, among other things, positive physical identification of the customer, which includes physically identifying the customer as per identification documents, retaining a copy of an identifying document, including a photograph, for the bank's records, obtaining an authorized customer sample signature witnessed by bank personnel, etc.

This procedure turns transfers of funds between banks, whose purpose is to maximize the depositor's yield, as being impractical, especially for amounts that are not very large and that are not worth the trouble. In any case, if the customer's goal in transferring funds from a financial institution A to a financial institution B is to benefit from better deposit terms, a different banking concept, referred to as “closed banking system,” may be employed whereby a customer may open a deposit account at financial institution B in a manner that does not require his positive physical identification as described above, and deposit into the account funds that are transferred from the customer's regular stand-alone account at financial institution A, provided that subsequent withdrawals of funds from the customer's account at financial institution B are performed by transferring funds back to the account at financial institution A from which the funds were originally transferred. According to this concept, since the customer cannot withdraw or transfer funds directly from the deposit account in financial institution B, positive physical identification of the customer is not a necessity in order for financial institution B to create a bank deposit and to receive the customer's funds. The details of the account in financial institution A are sufficient for financial institution B to carry out the transfer of funds from financial institution A where the customer typically has gone through physical identification and may thus give instructions regarding the withdrawal and/or transfer of the funds from the customer's account at financial institution A to any other account in the banking system.

In Israel the concept of a “closed banking system” has recently received regulatory attention, with the promulgation by the Commissioner of Financial Institutions of Proper Financial Banking Procedure 417 which was published in January, 2002 under the title: “Banking corporation activities in a closed system.” As per the terms of this specific procedure, a customer with a standard financial institution account at financial institution A may open a closed financial banking deposit account at financial institution B without having to physically appear at a branch of financial institution B. In order to be able to perform closed financial banking transactions under this specific procedure, the following requirements must be fulfilled:

The customer must sign a Deposit Management Agreement with financial institution B;

The funds transfer process must include the transfer of information sufficient to ensure that the owner of the deposit in financial institution B is the same as the owner of the account in financial institution A from which the funds were withdrawn;

At the end of the deposit period, the funds will be automatically returned to the account in financial institution A from which the funds originated, without any need for additional action by the customer.

While such a closed banking system might benefit banking customers, several barriers exist that prevent widespread and effective use of closed banking perception by banking customers. These barriers arise from the absence of closed banking systems and methods that provide for closed banking transactions that have what is referred to herein as “transparent settlement”—that is, closed banking transactions from the customer's order to make the closed banking deposit up to and including the actual interbank transfer of funds that do not require any additional action on the part of the customer beyond the customer issuing the closed banking deposit order itself—while fulfilling the following requirements:

Maximum availability and accessibility for customers;

Functional effectiveness by enabling customers to transfer any amount;

Simplicity and user-friendliness by enabling the customer to interface with a familiar and easy-to-use user-interface;

Operational efficiency by minimizing manual procedures; and

Minimum cost for the customer as well as the service provider.

Furthermore, additional business/marketing barriers exists. For example, a bank that seeks to offer closed banking services must undertake marketing efforts to attract customers that maintain their standard banking accounts in other institutions. Yet, marketing by banks tends to be more effective with respect to their own existing customers and weaker with respect to other banks' customers, with this effect becoming more pronounced in inverse proportion to the size of the bank.

Moreover, large and mid-sized banks have not made any great effort to promote closed banking, automated or otherwise, to the masses, presumably because easier customer access to closed banking would negatively affect the yield on their existing deposits as funds move more easily from one bank to another due to competition which harms their interest rate spreads and margins.

It thus follows that an automated banking system that enables customers to transfer funds in a transparent, accessible, simple, efficient and inexpensive manner for the purposes of making a closed banking deposit in another financial institution would be advantageous to customers. Moreover, such an automated banking system that would enjoy widespread use and that would enable practical accessibility of a variety of financial institutions offering closed banking deposits to a large potential and immediate customer base having the ability to perform an actual deposit and fund transfer by “a click of a button”, would be of greater advantage.

### SUMMARY OF THE INVENTION

The present invention provides for the automatic transfer of funds by customers as part of closed banking transactions, whereby banking customers may use various communication devices already available to and in use by them, as opposed to using special banking end equipment such as ATM machines etc., in order to perform complete closed banking deposit transactions in such a manner as to overcome the barriers described above. Several processes are provided, including providing the customer with one or more closed banking deposit options offered by one or more financial institutions, receiving a closed banking deposit order from the customer, and transferring the funds for the deposit without requiring any additional action on the part of the customer.

The present invention seeks to provide the following advantages:

Automatic and transparent settlement, in that the deposit order is conveyed via any of various communications devices available to the customer and is recorded by a receiving bank (RB). The amount of the deposit is reported by the RB to the transferring bank, preferably via an interbank clearinghouse and/or via direct presentment. The transaction will be honored by the transferring bank as per the terms of an account debit authorization agreement signed in advance by the customer.

Maximum availability and accessibility for the customer, in that the process is performed through standard communications devices that are already in use by the vast majority of the target clientele (e.g., telephone, cellular telephone, set-top T.V converter, Internet-enabled devices, etc.).

Functional effectiveness, in that any amount may be transferred using the present invention with no artificial limits. The decision to honor the funds transfer by the transferring bank is, as to be expected, subject only to its rights and obligations under the law. Thus, for example, a transfer request may be charged back in the event of insufficient funds.

Operational effectiveness, in that as soon as the customer gives a closed banking deposit order, the rest of the process is automatic and requires no further manual intervention.

Simplicity and friendliness, in that the user interface that the customer encounters for the purpose of receiving a deposit menu listing, for issuing depositing order, and/or for receiving information about his/her existing deposits, is embodied using familiar and easy-to-use means such as interactive Voice Response (IVR) systems, cable or satellite television interactive screens, Short Message Service (SMS), Wireless Access Protocol (WAP), web sites and/or any kind of Internet-based pages, Hypertext Markup Language (HTML) forms, Extensible Markup Language (XML) forms, etc., or a human representative.

Low cost, in that the communications devices that may be used by the customer to interact with a receiving bank through any interface are already in the customer's possession and require no special adaptation, and that once the closed banking deposit transaction is initiated through the interface all further processing is automatic, and no costly manual intervention is required.

The present invention also includes a process for providing an infrastructure to provide widespread use of closed banking transactions as described herein by large numbers of customers. This process typically includes the participation as key players of non-banking entities, such as telecommunications companies, web portals, cable television companies, satellite television companies, etc., herein collectively referred to as “recruiting agents,” which will recruit customers to the RB's closed banking program. The recruitment of customers will include the receipt of customer authorization for the debiting of the customer's account/s in favor of the RB, preferably for the purposes of a closed banking system alone. This will preferably be accomplished by having the customer sign an account debit authorization form as per accepted practice, or by any other means that will be regarded as admissible for the purposes of achieving a customer's consent to have his/her account debited as part of a closed banking transaction. The recruitment will likely include the customer signing other legal forms as well, such as a general, and preferably uniform, agreement for the management of deposits that is acceptable to all financial institutions offering such closed banking services, and that will have legal effect with regard to the specific financial institution that the customer chooses to perform his closed banking transactions.

Once these agreements are signed and the customer is added to the closed banking program, the customer may perform automatic closed banking deposits by interfacing with the RB using a variety of interfaces and media, such as to receive a menu presenting a listing of closed banking deposit options. Any such interface with the customer is regarded herein as an interaction with the RB and as an interface provided by the RB, even where the interface is provided by a third party. For example a technical interface provider, such as a web portal or a cable television operator, may employ an interactive interface to display on the customer's computer/television screen a menu of available deposits being offered by any participating financial institution that has entered into an agreement with the RB, while the data transfer via such interface is preferably generated and/or recorded by the RB using conventional means. The web portal/cable television operator itself may or may not have a business interest in the RB and may be one of several of the RB's recruiting agents, an exclusive recruiting agent, or not be a recruiting agent at all.

The business relationship between the RB, the recruiting agent, and other parties may be understood as follows. The RB is the legal, banking and technical axis through which the entire system of the present invention interfaces with the laws and processes of the banking world, and to whom depositors' funds are transferred, whether for deposit at the RB or at other financial institutions that provide deposit options. Despite its central procedural and legal role, at the practical business level the RB, per se, is the weaker and less important element in the system, inasmuch as the source of its power and character, as important as they are, originates from the financial institution license in its possession that allows it to operate in this field.

Generally speaking, entities that possess a financial institution license, as described above, widely exist, and furthermore, a license to set up a financial institution or to acquire a financial institution as described above may be acquired from the appropriate regulating body according to its required conditions. Provided that the requesting party is respected and strong from a financial point of view (such as a large telecommunications company), there is no reason why the regulating body would not willingly grant the request. Therefore, it may be assumed that the entity that will provide the business backbone of the present invention is one of great ability in at least one of the following areas:

A great and effective marketing ability for recruiting clients to participate in a closed banking program as described hereinabove. Such entities may be large companies with a broad customer base, and whose normal business involves contact, preferably direct, with customers via a network of stores, through direct marketing campaigns, by operating customer service centers, etc.

An entity that can give the RB highly successful, and preferably visual, interactive client interface services for displaying the RB's system for providing the closed banking transaction and information. An entity such as this may be, for example, a major Internet portal, or a cable/satellite company, who provide a closed banking system interface upon interactive screens that they provide, etc.

It is logical, therefore, that the RB may be controlled by an entity or entities such as is described hereinabove that possess the above qualities.

Regarding the actual deposit of funds, the present invention enables customers to make a deposit based on a deposit option offered by the RB, itself being a financial institution, or offered by another financial institution using the RB closed banking program interface and the RB funds withdrawal capabilities. In the first case, where a customer who had joined the RB closed banking program made a deposit order, using any suitable interface method, to be deposited in the RB itself, the funds are transferred to the RB and the deposit is recorded in the customer's name at the RB. In the second case, where the RB distributes funds to other financial institutions, the RB will offer, through one or more of its supplied interfaces, deposit options at other financial institutions that have contracted with the RB for this service, typically in return for a commission or fee. The RB will offer deposit options to its customers in the name of the other financial institutions, herein referred to as Foreign Offering Banks (FOB), where each FOB deposit option is presented to the customer together with the name of the FOB. In this approach, the funds will be transferred from the customer's original source account to the RB's account, whereupon the RB will deposit in each of the FOB's accounts that it represents an amount equal to the aggregate total of deposits requests from all of its customers for that particular FOB. Likewise, the RB may forward the customer details for the individual deposits to the FOB in order to enable the FOB to record the individual accounts and maintain account relationships as per the principles of a closed banking system. Crediting of the customer's funds at the end of the deposit period will be performed, either where the FOB presents the credit order directly via the clearinghouse, or where the RB presents the credit order via the clearinghouse and presents a single aggregated debit request to the FOB. As a preferred alternative to forwarding the customer details to the FOB, the RB may offer the FOB accounting and depository management services and perform the customer account credit/debit services on its behalf, while the funds themselves are credited/debited to the FOB's account.

It is appreciated that references herein to activities performed by the RB may additionally or alternatively refer to any and all activities performed on behalf of the RB or in its name by the RB's recruiting agent or agents and/or by any other party.

In one aspect of the invention a banking method is provided including receiving an authorization from a customer to transfer funds belonging to the customer from a source financial institution as part of a closed banking transaction, where the receiving step includes receiving the authorization separate from any instruction to transfer funds, providing at least one closed banking deposit option to the customer via a communications device for selection thereat, receiving a deposit option selection from the communications device, and transferring funds from the source financial institution in accordance with the deposit option selection, where the transferring step includes effecting the transfer via an interbank clearing entity without requiring a specific approval from the source financial institution for the transfer.

In another aspect of the present invention the receiving an authorization step includes recruiting the customer to a closed banking program.

In another aspect of the present invention the receiving an authorization step includes receiving an authorization from the customer to transfer funds belonging to the customer from at least one account in the source financial institution.

In another aspect of the present invention the transferring step includes transferring the funds to a receiving bank for deposit therein.

In another aspect of the present invention the providing step includes providing the deposit option for a funds deposit in the receiving bank.

In another aspect of the present invention the transferring step includes transferring the funds to a receiving bank, the receiving bank distributing at least a portion of the funds to at least one bank other than the receiving bank for deposit therein.

In another aspect of the present invention the providing step includes providing at least one deposit option for a funds deposit in at least one bank other than the receiving bank.

In another aspect of the present invention the method further includes transferring the transferred funds back to the source financial institution after a predefined period of time.

In another aspect of the present invention any of the providing and receiving steps are performed by a non-banking concern.

In another aspect of the present invention any of the providing and receiving steps are performed by a cellular telephone service provider.

In another aspect of the present invention any of the providing and receiving steps are performed by a cable television provider.

In another aspect of the present invention any of the providing and receiving steps are performed by a satellite television provider.

In another aspect of the present invention the providing step includes indicating a funds transfer amount via the deposit option.

In another aspect of the present invention the providing step includes indicating an interest rate amount via the deposit option.

In another aspect of the present invention the method further includes soliciting the customer to provide the authorization.

In another aspect of the present invention the providing step includes providing via any of an IVR menu, a WAP menu, an SMS men, an HTML-based menu, and an XML-based menu.

In another aspect of the present invention the receiving a deposit option selection step includes receiving via any of an IVR interface, an SMS interface, a WAP interface, an HTML interface, and an XML interface.

In another aspect of the present invention a closed banking marketing method is provided including soliciting at least one customer of a source financial institution to use closed banking depository services offered by a financial institution, and causing the customer to effect a legal agreement with the financial institution authorizing the debiting of the customer's deposit account at a source financial institution, where any of the soliciting and causing steps is performed by a recruiting agent being a non-banking entity.

In another aspect of the present invention a banking method is provided including soliciting at least one customer of a source financial institution to use closed banking depository services offered by another financial institution, causing the customer to effect a legal agreement with the other financial institution authorizing the debiting of the customer's deposit account at the source financial institution, where any of the soliciting and causing steps is performed by a recruiting agent being a non-banking entity, providing at least one closed banking deposit option to the customer via a communications device for selection thereat, receiving a deposit option selection from the communications device, and transferring funds from the source financial institution to the other financial institution in accordance with the deposit option selection, where the transferring step includes effecting the transfer via an interbank clearing entity without requiring a specific approval from the source financial institution for the transfer.

In another aspect of the present invention the causing step includes receiving an authorization from the customer to transfer funds belonging to the customer from at least one account in the source financial institution.

In another aspect of the present invention the transferring step includes transferring the funds to a receiving bank for deposit therein.

In another aspect of the present invention the providing step includes providing the deposit option for a funds deposit in the receiving bank.

In another aspect of the present invention the transferring step includes transferring the funds to a receiving bank, the receiving bank distributing at least a portion of the funds to at least one bank other than the receiving bank for deposit therein.

In another aspect of the present invention the providing step includes providing at least one deposit option for a funds deposit in at least one bank other than the receiving bank.

In another aspect of the present invention the method further includes transferring the transferred funds back to the source financial institution after a predefined period of time.

In another aspect of the present invention any of the soliciting, causing, providing and receiving steps are performed by a non-banking concern.

In another aspect of the present invention any of the soliciting, causing, providing and receiving steps are performed by a cellular telephone service provider.

In another aspect of the present invention any of the soliciting, causing, providing and receiving steps are performed by a cable television provider.

In another aspect of the present invention any of the soliciting, causing, providing and receiving steps are performed by a satellite television provider.

In another aspect of the present invention the providing step includes indicating a funds transfer amount via the deposit option.

In another aspect of the present invention the providing step includes indicating an interest rate amount via the deposit option.

In another aspect of the present invention the providing step includes providing via any of an IVR menu, a WAP menu, an SMS men, an HTML-based menu, and an XML-based menu.

In another aspect of the present invention the receiving a deposit option selection step includes receiving via any of an IVR interface, an SMS interface, a WAP interface, an HTML interface, and an XML interface.

In another aspect of the present invention a banking method is provided including providing at least one closed banking credit option to a closed banking customer via a communications device for selection thereat, receiving a credit option selection from the communications device, collateralizing a credit amount indicated by the credit option selection with at least one closed banking deposit transferred by the customer from the customer's account at the source financial institution, and transferring at least a portion of the credit amount from at least one credit offering bank to the customer's account at the source financial institution.

In another aspect of the present invention the method further includes approving the credit if the customer has sufficient closed banking deposits and for a sufficient deposit period such that they may be used as collateral for the credit.

In another aspect of the present invention the method further includes approving the credit where the amount of the credit that is to be transferred into the customer's account at the source financial institution satisfies a function of the amount of the deposits that originated from the account.

In another aspect of the present invention the method further includes transferring at least a portion of the collateral deposit to the credit offering bank after the expiration of the deposit period of the collateral deposit

In another aspect of the present invention the method further includes transferring a credit repayment amount from the customer's account at the source financial institution to the credit offering bank responsive to a credit repayment instruction from the customer, and reducing the credit amount by the credit repayment amount.

In another aspect of the present invention a banking system is provided including means for receiving an authorization from a customer to transfer funds belonging to the customer from a source financial institution as part of a closed banking transaction, where the means for receiving is operative to receive the authorization separate from any instruction to transfer funds, means for providing at least one closed banking deposit option to the customer via a communications device for selection thereat, means for receiving a deposit option selection from the communications device, and means for transferring funds from the source financial institution in accordance with the deposit option selection, where the means for transferring is operative to effect the transfer via an interbank clearing entity without requiring a specific approval from the source financial institution for the transfer.

In another aspect of the present invention the means for receiving an authorization is operative to receive an authorization is operative to recruit the customer to a closed banking program.

In another aspect of the present invention the means for receiving an authorization is operative to receive an authorization from the customer to transfer funds belonging to the customer from at least one account in the source financial institution.

In another aspect of the present invention the means for transferring is operative to transfer the funds to a receiving bank for deposit therein.

In another aspect of the present invention the means for providing is operative to provide the deposit option for a funds deposit in the receiving bank.

In another aspect of the present invention the means for transferring is operative to transfer the funds to a receiving bank, where the receiving bank is operative to distribute at least a portion of the funds to at least one bank other than the receiving bank for deposit therein.

In another aspect of the present invention the means for providing is operative to provide at least one deposit option for a funds deposit in at least one bank other than the receiving bank.

In another aspect of the present invention the system further includes means for transferring the transferred funds back to the source financial institution after a predefined period of time.

In another aspect of the present invention any of the means for providing and receiving are embodied in a non-banking concern.

In another aspect of the present invention any of the means for providing and receiving are embodied in a cellular telephone service provider.

In another aspect of the present invention any of the means for providing and receiving are embodied in a cable television provider.

In another aspect of the present invention any of the means for providing and receiving are embodied in a satellite television provider.

In another aspect of the present invention the means for providing is operative to indicate a funds transfer amount via the deposit option.

In another aspect of the present invention the means for providing is operative to indicate an interest rate amount via the deposit option.

In another aspect of the present invention the system further includes means for soliciting the customer to provide the authorization.

In another aspect of the present invention the means for providing is operative to provide via any of an IVR menu, a WAP menu, an SMS men, an HTML-based menu, and an XML-based menu.

In another aspect of the present invention the means for receiving a deposit option selection is operative to receive via any of an IVR interface, an SMS interface, a WAP interface, an HTML interface, and an XML interface.

In another aspect of the present invention a closed banking marketing system is provided including means for soliciting at least one customer of a source financial institution to use closed banking depository services offered by a financial institution, and means for causing the customer to effect a legal agreement with the financial institution authorizing the debiting of the customer's deposit account at a source financial institution, where any of the means for soliciting and causing are embodied in a recruiting agent being a non-banking entity.

In another aspect of the present invention a banking system is provided including means for soliciting at least one customer of a source financial institution to use closed banking depository services offered by another financial institution, means for causing the customer to effect a legal agreement with the other financial institution authorizing the debiting of the customer's deposit account at the source financial institution, where any of the means for soliciting and causing are embodied in a recruiting agent being a non-banking entity, means for providing at least one closed banking deposit option to the customer via a communications device for selection thereat, means for receiving a deposit option selection from the communications device, and means for transferring funds from the source financial institution to the other financial institution in accordance with the deposit option selection, where the means for transferring is operative to effect the transfer via an interbank clearing entity without requiring a specific approval from the source financial institution for the transfer.

In another aspect of the present invention the means for causing is operative to receive an authorization from the customer to transfer funds belonging to the customer from at least one account in the source financial institution.

In another aspect of the present invention the means for transferring is operative to transfer the funds to a receiving bank for deposit therein..

In another aspect of the present invention the means for providing is operative to provide the deposit option for a funds deposit in the receiving bank.

In another aspect of the present invention the means for transferring is operative to transfer the funds to a receiving bank, where the receiving bank is operative to distribute at least a portion of the funds to at least one bank other than the receiving bank for deposit therein.

In another aspect of the present invention the means for providing is operative to provide at least one deposit option for a funds deposit in at least one bank other than the receiving bank.

In another aspect of the present invention the system further includes means for transferring the transferred funds back to the source financial institution after a predefined period of time.

In another aspect of the present invention any of the means for soliciting, causing, providing and receiving are embodied in a non-banking concern.

In another aspect of the present invention any of the means for soliciting, causing, providing and receiving are embodied in a cellular telephone service provider.

In another aspect of the present invention any of the means for soliciting, causing, providing and receiving are embodied in a cable television provider.

In another aspect of the present invention any of the means for soliciting, causing, providing and receiving are embodied in a satellite television provider.

In another aspect of the present invention the means for providing is operative to indicate a funds transfer amount via the deposit option.

In another aspect of the present invention the means for providing is operative to indicate an interest rate amount via the deposit option.

In another aspect of the present invention the means for providing is operative to provide via any of an IVR menu, a WAP menu, an SMS men, an HTML-based menu, and an XML-based menu.

In another aspect of the present invention the means for receiving a deposit option selection is operative to receive via any of an IVR interface, an SMS interface, a WAP interface, an HTML interface, and an XML interface.

In another aspect of the present invention a banking system is provided including means for providing at least one closed banking credit option to a closed banking customer via a communications device for selection thereat, means for receiving a credit option selection from the communications device, means for collateralizing a credit amount indicated by the credit option selection with at least one closed banking deposit transferred by the customer from the customer's account at the source financial institution, and means for transferring at least a portion of the credit amount from at least one credit offering bank to the customer's account at the source financial institution.

In another aspect of the present invention the system further includes means for approving the credit if the customer has sufficient closed banking deposits and for a sufficient deposit period such that they may be used as collateral for the credit.

In another aspect of the present invention the system further includes means for approving the credit where the amount of the credit that is to be transferred into the customer's account at the source financial institution satisfies a function of the amount of the deposits that originated from the account.

In another aspect of the present invention the system further includes means for transferring at least a portion of the collateral deposit to the credit offering bank after the expiration of the deposit period of the collateral deposit

In another aspect of the present invention the system further includes means for transferring a credit repayment amount from the customer's account at the source financial institution to the credit offering bank responsive to a credit repayment instruction from the customer, and means for reducing the credit amount by the credit repayment amount.

### BRIEF DESCRIPTION OF THE DRAWINGS

The present invention will be understood and appreciated more fully from the following descriptions taken in conjunction with the appended drawings in which:

FIG. 1 is a simplified flowchart illustration of a method for providing a closed banking infrastructure, operative in accordance with a preferred embodiment of the present invention;

FIGS. 2A, 2B, and 2C, taken together, is a simplified flowchart illustration of a method for setting up and performing closed banking transactions, operative in accordance with a preferred embodiment of the present invention;

FIGS. 3A and 3B, taken together, is a simplified flowchart illustration of a method for receiving a collateralized loan, herein referred to as a credit, in a closed banking system, operative in accordance with a preferred embodiment of the present invention; and

FIGS. 4A-4N are simplified tabular illustrations useful in understanding an exemplary implementation of the present invention.

### DETAILED DESCRIPTION OF PREFERRED EMBODIMENTS

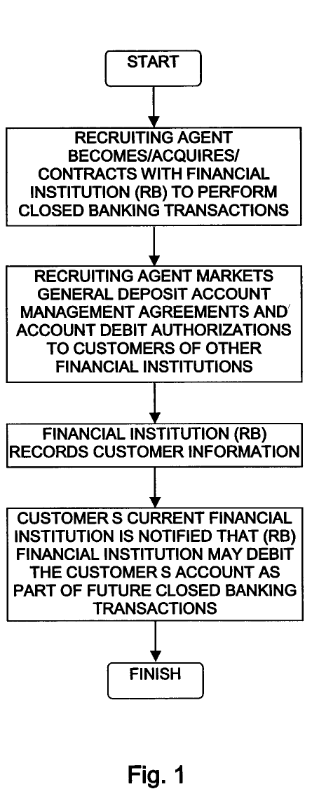

Reference is now made to FIG. 1, which is a simplified flowchart illustration of a method for providing a closed banking infrastructure, operative in accordance with a preferred embodiment of the present invention. In the method of FIG. 1, a concern, referred to herein as a “recruiting agent” and typically being a non-banking concern such as a cellular or PSTN telephone service provider, a web portal, a cable or satellite television company, or any other entity having a marketing capability, enters into an agreement with, becomes, establishes, or partly or wholly acquires a financial institution, such as a bank, and referred to herein as a “recipient bank” (RB), that is capable of and/or entitled to and/or interested in offering closed banking depository services. In such an arrangement the recruiting agent preferably recruits customers from other financial institutions to the closed banking program and services offered by the RB. The recruiting process typically includes the customer signing or otherwise effecting a legal agreement with the RB authorizing the debiting of one or more of the customer's account at his current financial institution, referred to herein as the “source financial institution,” as per instructions that the customer may give periodically. Marketing of the closed banking program membership forms may be accomplished in any of the accepted methods for the distribution of such material, such as by way of mass mailings to the existing customers of the recruiting agent. Other recruiting techniques may include:

Mailing a sign-up kit, which includes relevant forms, a marketing leaflet, and a return envelope, to its existing customer base—or to any other customer data base that may be purchased or licensed for this purpose;

Having sales associates in shopping malls, workplaces, mobile marketing units, etc. personally sign up passers-by;

Signing up customers at the recruiting agent's chain of service centers or sales outlets;

Via “blind” direct mailing to potential customers' mailboxes;

Sending forms as file attachments to email messages sent to known customer addresses or supplied for this purpose by requests submitted via customer service representatives, SMS, Internet, WAP, and the like;

Downloading forms from web sites and/or portals and/or enabling electronic forms submission etc.;

By providing a return fax service and publicizing its number in various media (e.g., television, newspapers, etc.);

Using any other physical or electronic means that are suitable for recruiting customers to make closed banking transactions.

Once a customer has been recruited, the RB then preferably records the customer's details as part of its closed banking program. Where the specific regulations or procedures regarding electronic finds transfer account debiting requires informing the source financial institution of the authorization granted by the customer and/or receiving the approval of the source financial institution, this will be carried out, preferably by providing a copy of the signed authorization form to the source financial institution.

The customer's authorization to transfer funds to the RB preferably grants the RB the legal and practical ability to withdraw funds from the customer's account at the source financial institution via an “interbank clearing entity,” which may be any central clearinghouse or a network of clearing houses that acts as an intermediary agent to transfer funds between banks, such as Israel's “Masav—Interbank Clearing Center” or such as the U.S. “ACH” service. If a direct bilateral funds withdrawal agreement between the RB and any specific source financial institution is obtained, then references herein to interbank clearing may be understood within the context of such a bilateral agreement.

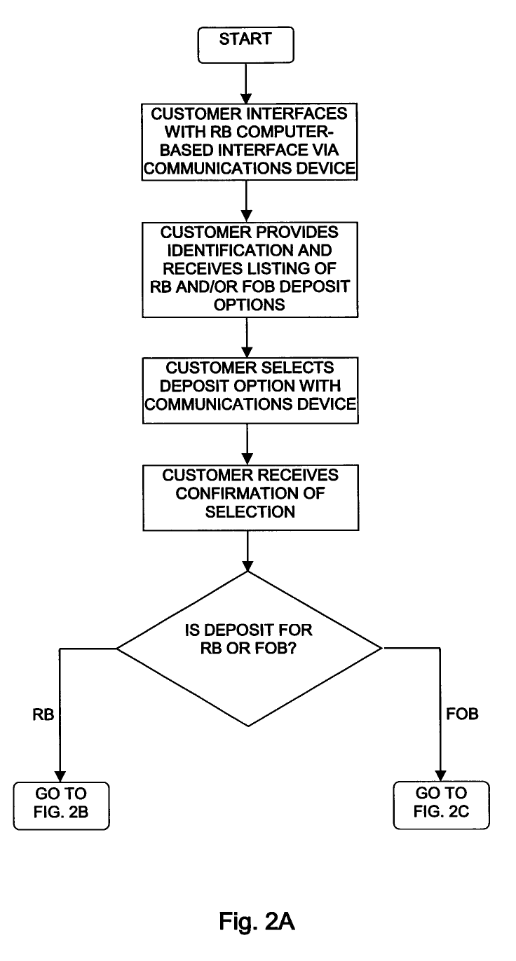

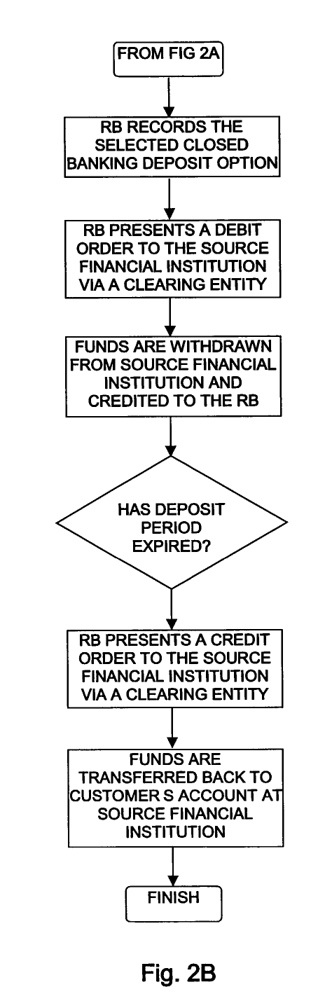

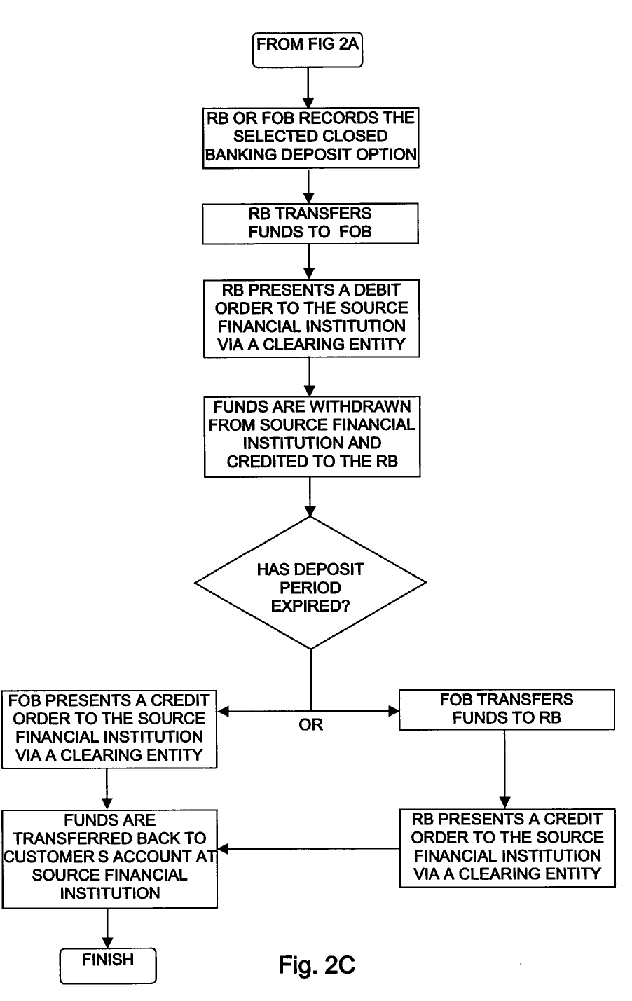

Reference is now made to FIGS. 2A, 2B, and 2C, which, taken together, is a simplified flowchart illustration of a method for performing closed banking transactions, operative in accordance with a preferred embodiment of the present invention. The method of FIGS. 2A, 2B, and 2C describes the process of transferring funds in a closed banking system from a source financial institution to a RB in response to a customer's order that is transmitted via an ordinary communications device. In the method of FIGS. 2A, 2B, and 2C, a customer who has given his authorization for the RB to transfer funds from his source financial institution and who wishes to transfer funds from his source financial institution to the RB uses a standard telephone, cellular telephone, Internet-capable computer terminal, cable or satellite television set-top box, or any other known communication means to contact and communicate with a preferably computer-based interface provided by the RB. The RB's interface preferably communicates with the customer using conventional techniques, such as Interactive Voice Response (IVR), Short Message Service (SMS), cable/satellite television interactive screens, or any kind of Internet communications means such as may be provided by/on web sites and/or web portals, and that may operate in accordance with any conventional technique such as Wireless Access Protocol (WAP), Hypertext Markup Language (HTML) forms, Extensible Markup Language (XML) forms, etc. For identification and/or for security purposes, the customer may be asked to provide his/her identification login, preferably established during the recruitment stage, and preferably being numeric, such as an ID or social security number and/or a password, preferably numeric, such as a Personal Identification Number (PIN), previously issued to the customer and known to the RB. The customer may then receive a listing of deposit options offered by the RB and/or offered on behalf of another financial institution, referred herein as a foreign offering bank (FOB), that has contracted with the RB to do so. As part of the agreement, the RB will preferably show through one or more of its user interfaces closed banking deposit options offered by the FOB. When a customer wishes to deposit funds in an FOB, the RB withdraws the required funds from the customer's original source account as per its authorization agreements and transfers funds to the FOB. Optionally if the RB and FOB come to such an agreement, the RB can manage the recording of the deposits and the required accounting on behalf of the FOB, while transferring the funds themselves to the FOB.

Each deposit option may indicate one or more deposit terms, such as a deposit amount or amount range, an interest rate quote or interest rate range quote, a type of indexing, a deposit period, an instruction to perform the deposit immediately, to automatically perform a one-time or recurring deposit in the future, etc. Additionally or alternatively, the customer may specify one or more deposit terms, such as by entering a deposit amount, deposit period, etc., and receive a deposit option that is dynamically-generated in accordance with pre-defined deposit option generation rules. For example, the interest rate quote may vary based on the deposit amount that the customer is interested in depositing, the deposit period, etc., based on pre-defined formulae or tables.

If the customer executes a deposit order in accordance with any of the deposit options presented, the RB may then provide the customer with a technical confirmation of the deposit option selection preferably using the current open channel between them using any means, such as by IVR recorded messages, SMS, WAP, Internet pages, or by emailing an electronic confirmation to the customer at an email address known to RB, by sending a confirmation letter to the customer's physical address, etc.

If the customer selection indicates that the customer wishes to deposit funds in the RB itself, the RB registers the deposit internally, and, being authorized to withdraw the funds for the deposit from the customer's source financial institution, presents to the appropriate interbank clearing entity a debit order addressed to the customer's account at the source financial institution. The interbank clearing entity then withdraws the funds from the customer's source financial institution and transfers them to the RB.

It is appreciated that the process of presenting charges to the interbank clearing entity, its withdrawal of funds, and their transfer to the RB are described herein in a simplified and illustrative manner only. Typically, this process will be done in a centralized batch configuration where the RB compiles a list of deposit requests within a given time frame, such as on a daily basis, that will normally include charging instructions to be issued to the source entities in the financial institutions for each customer. The RB, or its agent, then presents the list to the clearing entity.

The process of receiving funds from the clearing entity is also typically carried out using batch processes. For example, in the State of Israel the interbank clearing agent, “Masav”, transfers the funds within one business day, where the credit/debit value date is defined as the date that the list is presented to it.

When dealing with a network of clearinghouses, such as in a large country with many banks, it is not unusual that the transfer of funds takes longer, but as the process is electronic and does not require the physical transfer of bank draft documents, there should not be any significant delays, and it is still possible to define the credit/debit date as the date that the list was presented to the first clearing entity.

Typically, unless the source financial institution subsequently requests that the funds be returned, such as by presenting a charge-back order to the clearing entity, such as where the customer has insufficient funds at the source financial institution to cover the amount the customer wishes to deposit at the RB, the funds remain with the RB and the closed banking transaction becomes final. Where a funds return request is made, the RB may revoke the deposit and/or revoke any future already-ordered transactions such as in the case of future recurring deposit orders. Likewise, the RB may decide, as per its own considerations, to temporarily or permanently block a customer, preferably at the interactive interface level, from making additional closed banking transactions, either with respect to a particular source account or at all. The process of handling returns should preferably be almost totally automatic. For example, a file may be received from the clearing entity including list of returns that identifies the problematic customer/deposit with a unique identification number, such as a serial or a reference number that is generated by the original presenter of the debit/credit, i.e. the RB itself.

Once the transfer of funds is completed, the RB may notify the customer that the deposit has been made and may do so via any suitable electronic means or via regular mail.

During the course of the deposit period, the RB may allow the customer, pursuant to the prevailing statutes and regulations, it's business reasoning, and the terms of the original deposit, to issue instructions that amend the original terms of the deposit. For example, the customer may wish to change the length of the term of the deposit, redeem the deposit, convert the deposit either immediately or at the end of the term or any other date to another deposit, etc. These instructions, to the extent allowed, may be transmitted to the RB in any manner enabled by the RB, including telephone calls with the customer service representative, or electronically via any of the available user interfaces and methods described hereinabove.

At the end of the deposit period, (references to “end of the deposit period” herein refer to the end of the original term or to the extended time periods, early redemptions, or converted deposits) the RB automatically transfers the customer's total funds, principal plus any accrued interest, etc., back to the customer's account at the source financial institution, preferably by presenting a credit order to an interbank clearing entity that is addressed to the customers account at the source financial institution.

If a customer chooses to deposit funds in a FOB, then the following procedures are to take place. An “accountancy agent,” being a RB that provides deposit record management as well as the financial accounting required for such services to an FOB, records the deposits in its books. Furthermore, the RB may be expected to provide the FOB with various levels of reporting as required, such as in order to accurately reflect the financial position of the FOB when preparing statements required by the Central Bank. Alternatively, the RB does not provide accountancy agent services to the FOB. In this case, the RB transfers the information required for deposit registration to the FOB, who then manages the deposits on its own. Even in this scenario it is conceivable that the RB will elect to maintain parallel records in order to enable financial audits and to provide financial control for the transfer of funds between itself and the FOB.

Whether or not the RB acts as the FOB's accountancy agent, the RB then transfers funds to the FOB account by means agreed upon between them. Such activity is typically a back office procedure where general reconciliation is performed between the FOB and RB. The RB credits the FOB in an amount that equals the aggregate total of the deposits that were received by the RB for the FOB within a given time frame, such as on a daily basis, through the provided customer interfaces. Back-office funds transfers between the RB and the FOB may be carried out by having the FOB authorize the RB to initiate direct activity (i.e., credit/debit) in the FOB's bank accounts, or by transferring funds by check or bank transfer or any other mutually acceptable method.

The RB then presents to the interbank clearing entity a debit order addressed to the customer's account at the source financial institution, such as by using the means and/or methods described above.

As before, unless the source financial institution subsequently requests, within the time period it is entitled to, that the funds be returned, the funds remain with the RB, and the deposit transaction becomes final. Where a funds return request is made, the RB may revoke the deposit and/or inform the FOB who may revoke the deposit itself, whereupon the RB debits the FOB account with the sum of the return. Such returns transactions between the RB and the FOB are typically carried out as back office activities. Preferably, they are part of the general reconciliation between the RB and the FOB, where the RB charges the FOB an amount equal to the aggregate total of the returns received in the RB account during the relevant time period, such as on a daily basis, and based on the actual charges presented by the RB to its customers that had requested to deposit funds in the FOB.

As indicated above, in the event of a return request the RB may elect to block a customer temporarily/permanently from making additional closed banking transactions, either with respect to a particular source account or at all. Also as stated above, the handling of returns is preferably be performed in an automated manner, such as via receipt of a file including a list of returns from the clearinghouse that indicates customer/deposit identification numbers, such as a serial or reference number that is generated by the original presenter of the debit/credit.

Once the transfer of funds is completed, the RB, the FOB, or the RB on behalf of the FOB, may notify the customer that the deposit has been made via any suitable electronic means or via regular mail.

At the end of the deposit period, which may be subject to extension or shortening orders, funds are returned back to the customer's account at the source financial institution, such as directly by the FOB, where the FOB presents a credit order to the source financial institution preferably via a clearing entity. Alternatively and preferably, the RB credits the customer's source financial institution account, preferably by presenting a credit order to the source financial institution via a clearing entity. The funds are then transferred from the FOB account to the RB using any suitable means agreed upon for back-office reconciliation.

If the funds that are transferred to the RB are for deposit in an FOB, then the funds are transferred to the FOB and are its responsibility. The FOB may use the funds for any purpose, such as it does with any of its regular non closed banking deposits ,and in compliance with the regular rules to which it is subject, such as for providing credit to any party it so wishes. If the funds are deposited in the RB, and assuming that the RB is not a “normal” financial corporation and is not interested in providing active banking, including, for example, providing credit, excluding a non-risk credit made specifically to a customer with deposits in the system as described herein, but exclusively or mainly in providing closed banking depository services, the funds that the RB will receive may be invested by it in low-risk investments whose characteristics (type of indexing, deposit period, etc.) are suited to the deposits that it offers and whose yield is higher than that is offered to individual depositors. Such investments may consist of deposits in other banks or financial institutions where interest rate would be higher due to the large sums involved. Government bonds and/or other issues that match the offered deposits period and possessing a higher internal rate of return (IRR), may also be used to invest the deposited funds. A RB that operates in this manner may especially benefit from a high ratio of deposits to self-capital thanks to minimal risk associated with its activities.

Since the funds are deposited into the RB through customer instructions received via interfaces of the RB's computers, the RB may adjust, whether for itself or for an FOB, and in a preferably on-line manner, the supply of offered deposits and thence the absorption of funds that comes as a result. The aforementioned control may take place, for example, by updating the current deposit conditions offered by the relevant RB/FOB via a customer interface menu in accordance with conventional dynamic information systems management techniques. This may include changing the interest rate offered for a deposit, adding a deposit option to the menu, removing a deposit option from the menu and/or blocking further deposits, setting deposit minimums and/or maximums amounts, etc.

These adjustment conditions may be provided to the RB by the relevant financial institution that offers depository services, according to a decision that it receives in a certain time point and/or as a predefined instruction that defines for the RB a business rule, such as enabling deposits in a deposit account X until receipt of accumulated deposit instructions of Y monetary units, or changing the offered interest rates for deposit account X as a predefined function according to a table, formula, etc. of accumulated deposit instructions that were received for that deposit account, etc. Similar adjustment services could likewise be provided in connection with supplying credit as described herein.

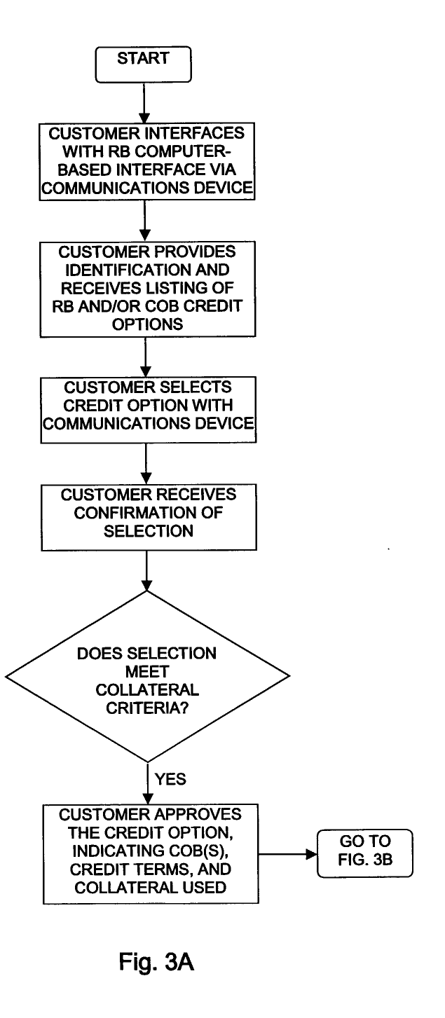

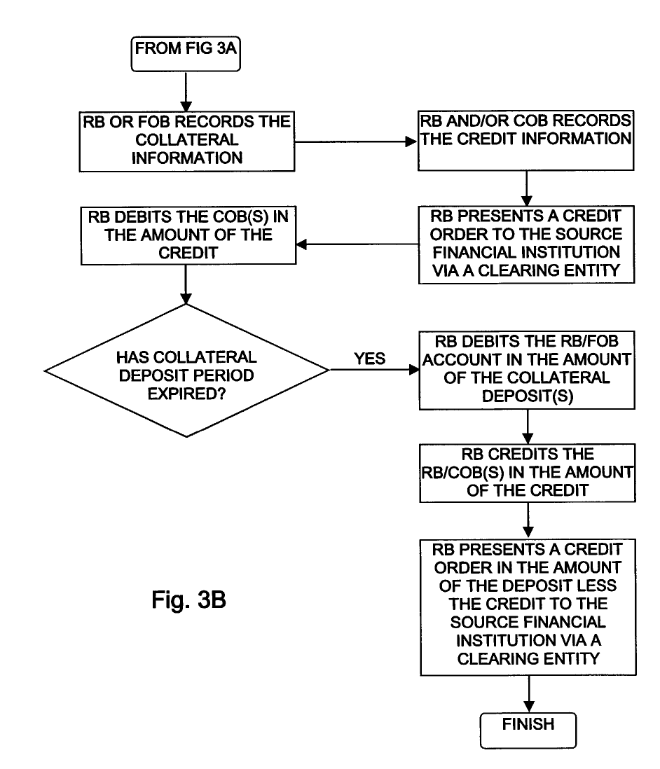

Reference is now made to FIGS. 3A and 3B, which, taken together, is a simplified flowchart illustration of a method for receiving a collateralized loan, herein referred to as a credit, in a closed banking system, operative in accordance with a preferred embodiment of the present invention. In the method of FIGS. 3A and 3B, a customer who has deposited funds in an RB and/or an FOB in accordance with the methods described hereinabove, communicates with the RB as described hereinabove and asks to receive credit, such as by specifying an amount, a period of time indicating the duration of the credit, desired credit terms, etc., or by selecting from a menu of predefined credit options or credit options that are automatically generated based on the nature of the customer's existing deposits and that may be used as collateral. The RB then checks, preferably according to any suitable pre-defined business rules, whether the customer has sufficient closed banking deposits in the RB and/or in any participating FOB, and for a sufficient deposit period, such that they may be used as collateral for the credit and approves some or all of the requested credit amount or disapproves the credit request. Preferably, the RB will regard a deposit to be a possible collateral option for a given credit request only if the deposit originated from the customer's source financial institution account to which the credit funds transfer is requested. The RB also preferably determines that the approved credit amount that will be transferred into the customer's account at his/her source financial institution will be a function of the amount of the collateral deposits that originated from that account. For example, the RB may require that the approved credit amount that will be transferred into the customer's account at his/her source financial institution be less than the amount of the collateral deposits that originated from that account. If sufficient closed banking funds are available, one or more predefined financial institutions that have indicated their availability to provide such credit services are selected by the customer, preferably according to the type of credit it is willing to give, how much credit it is willing to extend, its credit terms, etc. Such financial institutions are referred to herein as credit offering banks (COB), and may include the RB, any FOB, or any other financial institution capable of extending credit as described herein. The customer then approves the credit option indicating the COB(s), the terms of the credit, and the deposit(s) that will act as collateral.

Once the credit option has been approved by the customer, the RB preferably records the credit as provided by the selected COB(s), as well as each collateral deposit. If any of the collateral deposits is managed in a FOB that does not uses the RB as an accountancy agent, the RB preferably informs the FOB of the credit transaction, whereupon the FOB records the relationship between the collateral deposit and the credit transaction. The RB presents, preferably via an interbank clearing entity, a credit order to the customer's account at the source financial institution in the amount of the approved credit. The RB debits the COB in the amount of the credit by any suitable method agreed upon between them. As described hereinabove, such activity is typically a back office procedure where general reconciliation is performed between the COB and RB. Periodically, such as on a daily basis, the RB debits the COB account, or the COB credits the RB account, in an amount that equals the aggregate total of the credits that were extended by the COB and given by the RB to customers. When the deposit period of the collateral deposit expires, the RB calculates the value of the collateral deposit, debits the financial institution where the deposit existed in the total amount of the deposit, calculates the value of the credit, credits the COB account in the amount of the credit, and credits the customer's account at the source financial institution in the amount of the closed banking deposit less the credit amount. Additionally or alternatively, where the nature of the credit permits, the customer may instruct that some or all of the credit amount be repaid prior to the expiration of the deposit period of the collateral deposit. When this occurs, the customer's account at the source financial institution is debited in the amount of the repaid credit. The RB then receives the repayment funds, transfers the money to the COB, and reduces the recorded credit balance in the amount of the repayment. Later, when the deposit period of the collateral deposit expires, the normal procedure as described hereinabove is performed with regard to the remaining credit balance.

The above example of funds clearing is illustrative only, and other methods may be used. For example, multiple closed banking deposits may have been made from the same customer account at the source financial institution that may then be collectively used as collateral for the credit. In this case, an partial repayment may be made of the credit against each component of the collateral as its deposit period expires, with a final repayment being made at the expiration of the last component of the collateral.

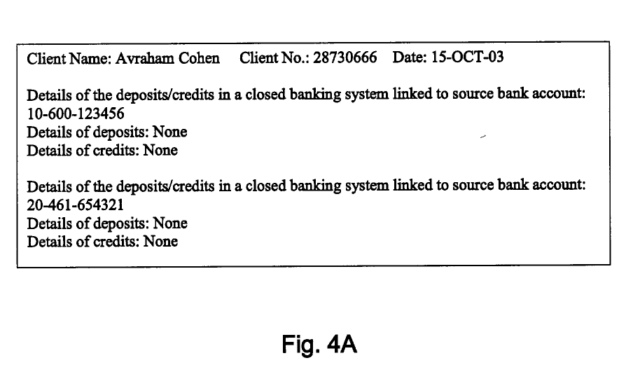

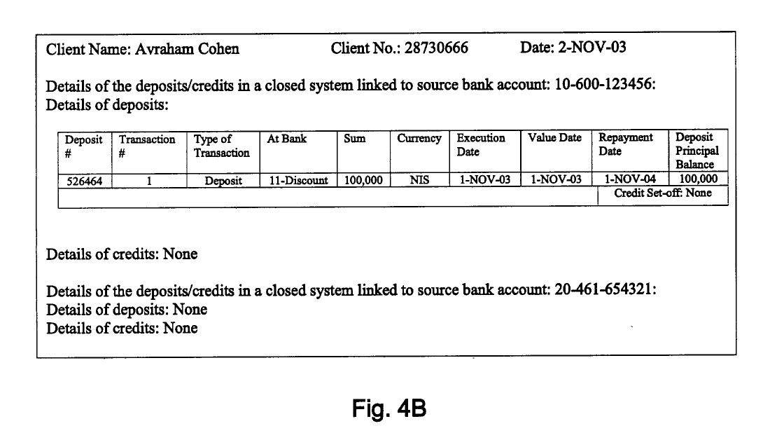

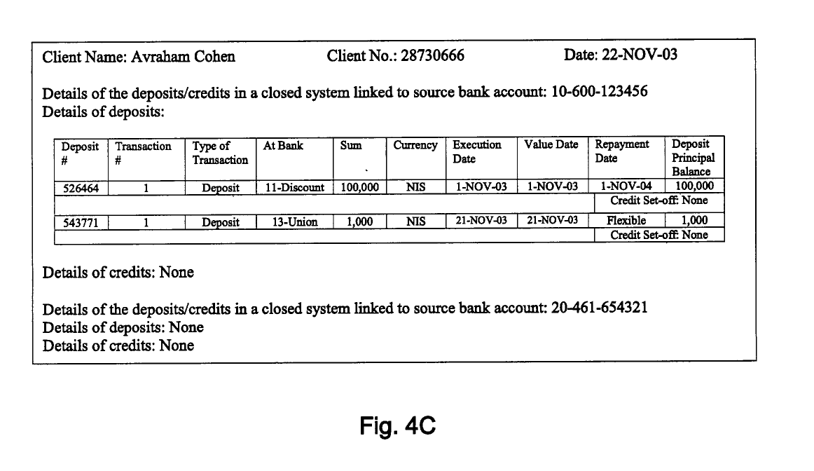

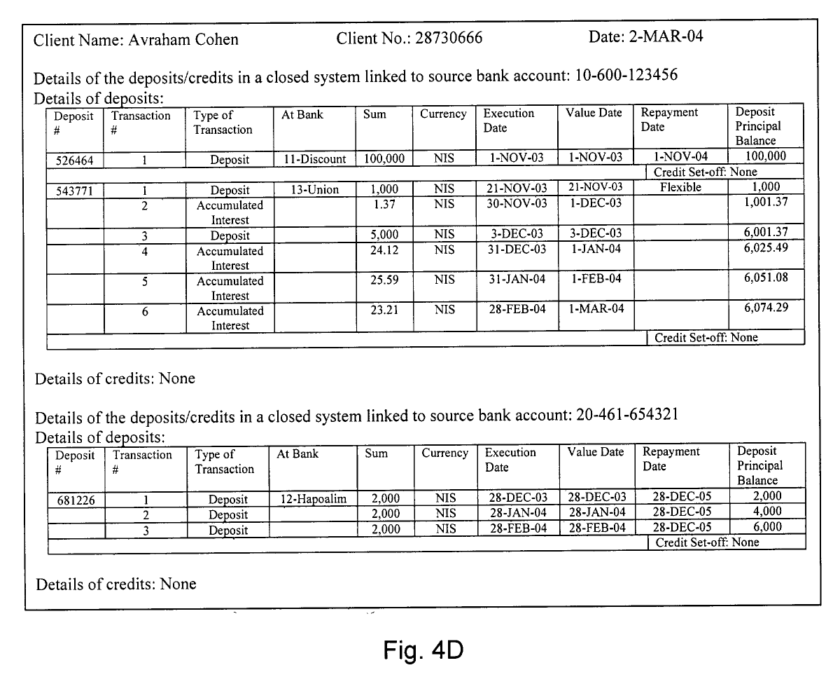

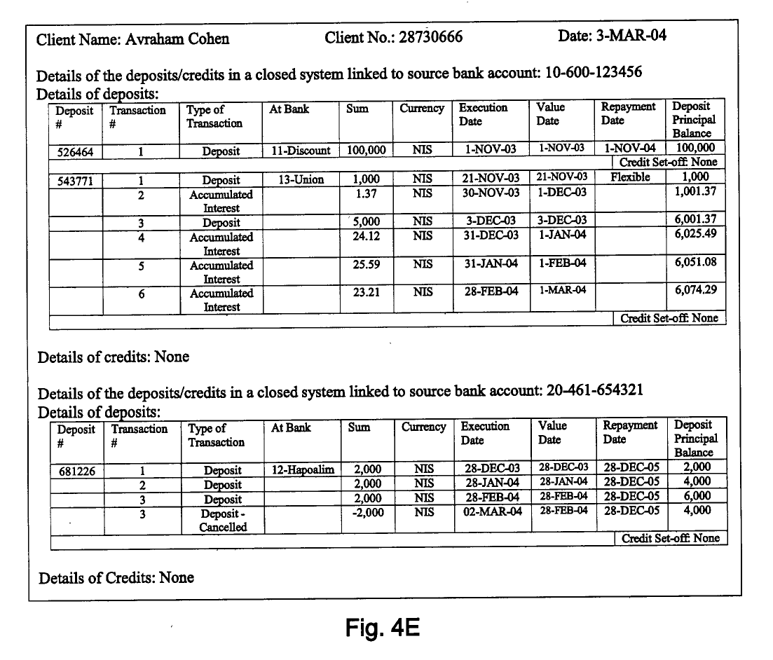

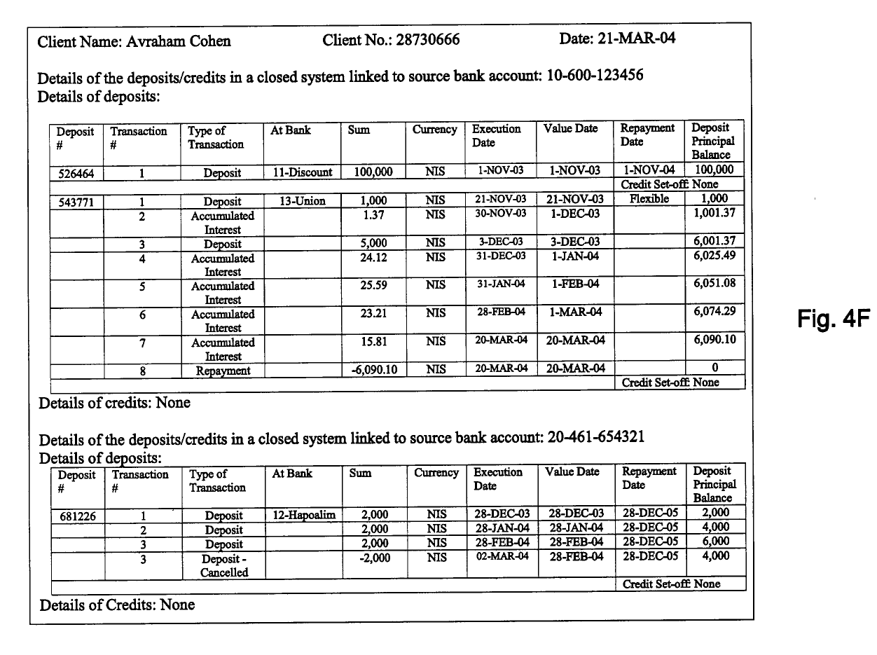

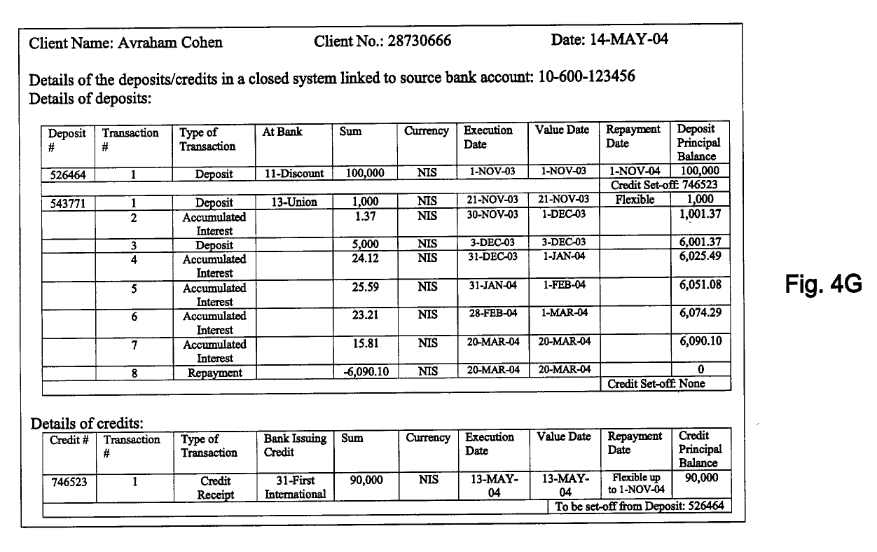

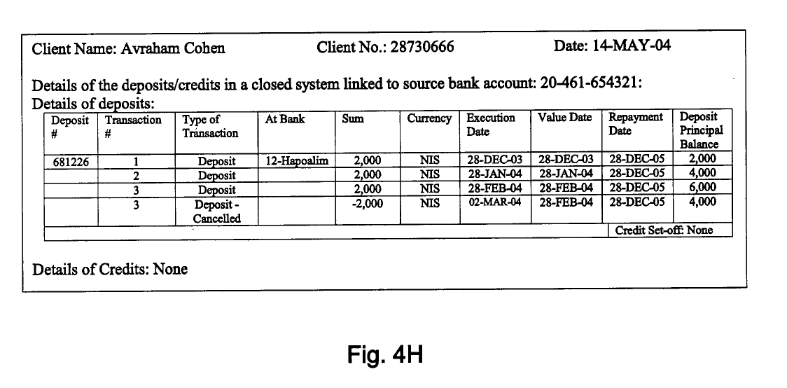

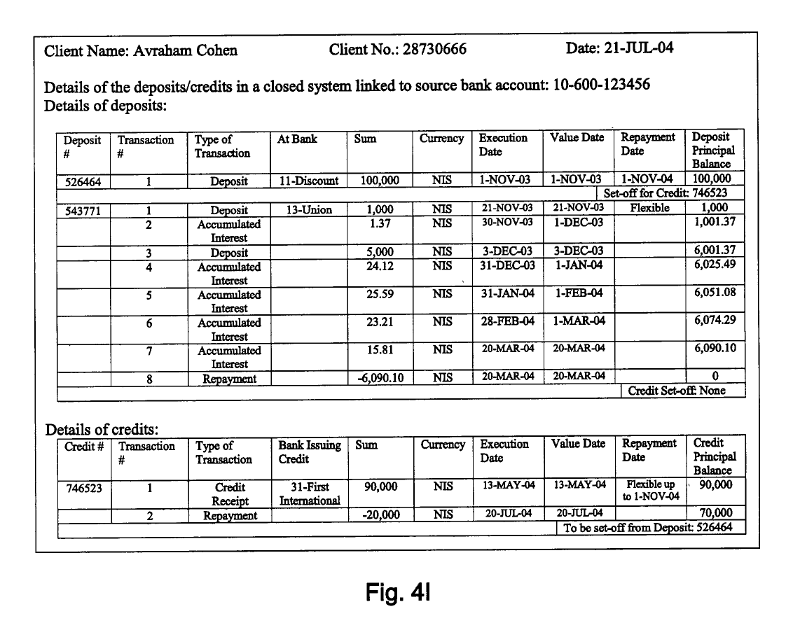

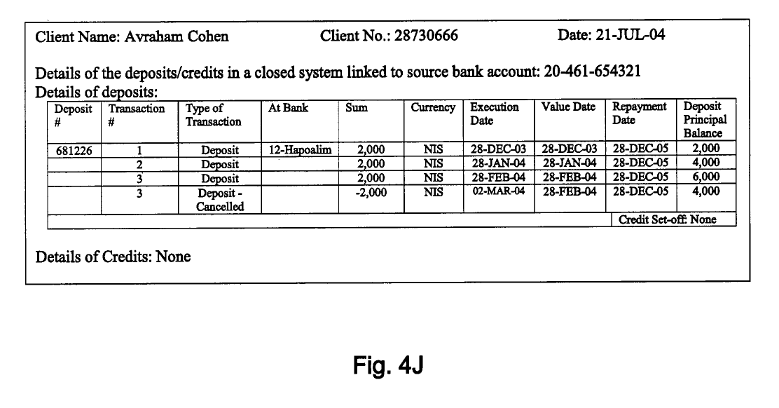

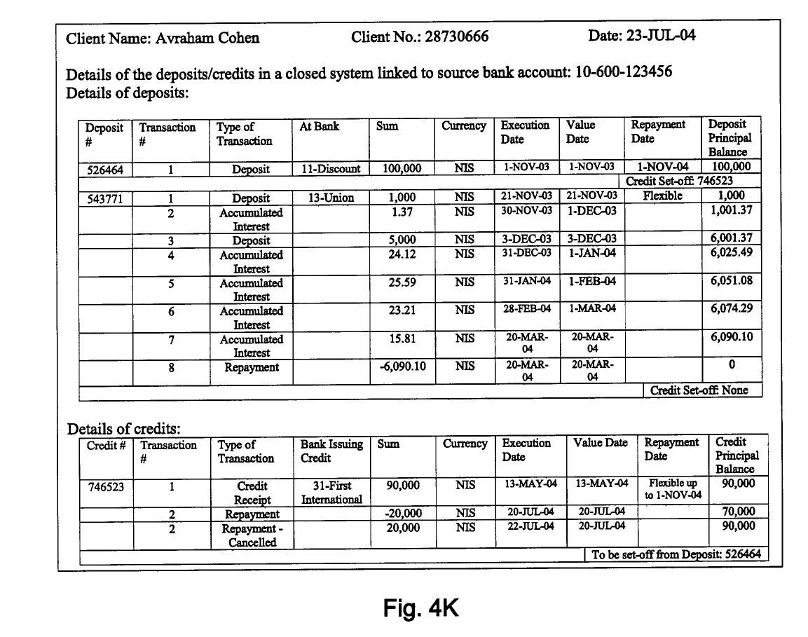

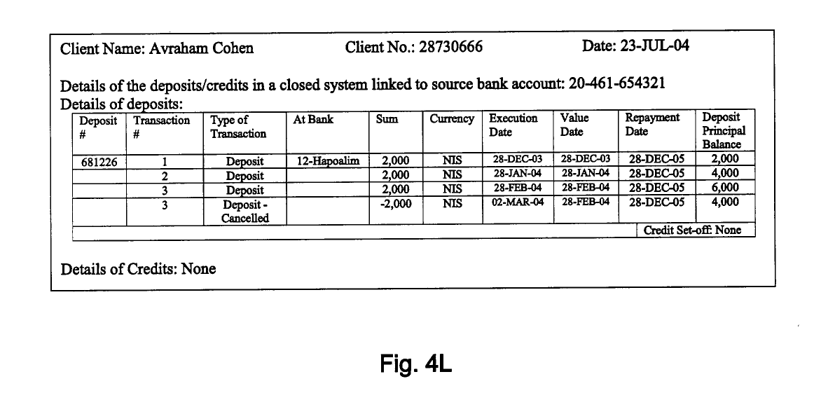

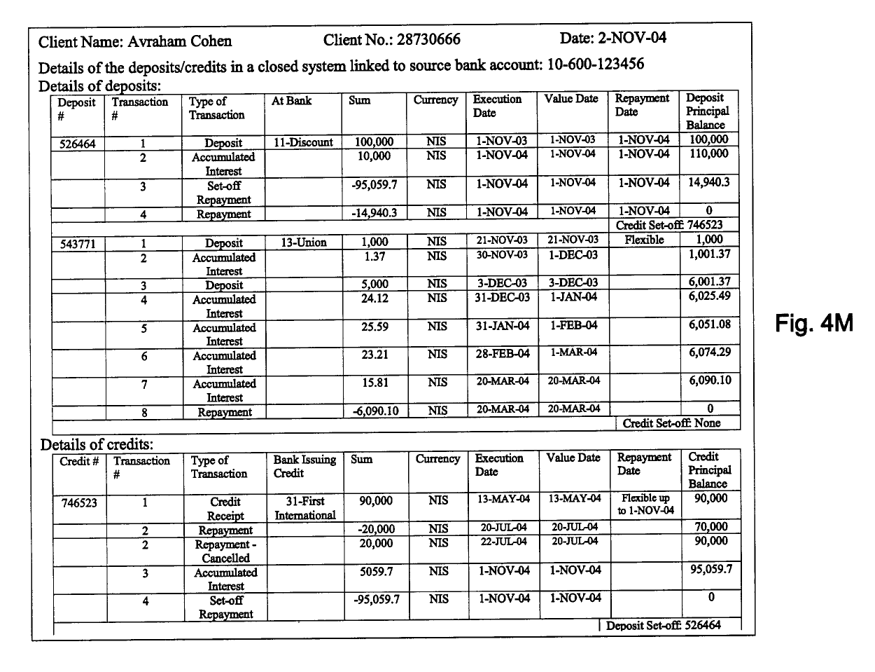

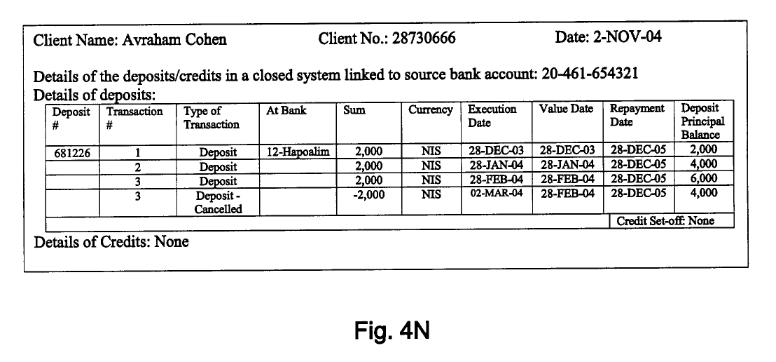

Reference is now made to FIGS. 4A-4N, which are simplified tabular illustrations useful in understanding an exemplary implementation of the present invention. In the example the following assumptions apply:

1. The client, Mr. Avraham Cohen, maintains 2 regular bank accounts that serve as source accounts:

1.1 At the Leumi Bank, number: 10-600-123456

1.2 At the Mizrahi Bank, number: 20-461-654321

2. The transit account of the RB, which the clearing house debits/charges, is one account, managed at the RB itself.

The RB will have a Banking Institutional Code of 95.

This account as having the number: 95-001-111111.

In principal, the RB can manage this account at any financial institution. Also, in principal, the RB is in fact likely to define a number of additional transit accounts in order to facilitate accounting auditing.

3. The FOB and the COB accounts are also managed at the RB itself:

3.1 The FOB account belonging to Discount Bank 95-001-119911

3.2 The COB account belonging to Discount Bank 95-001-118811

3.3 The FOB account belonging to Leumi Bank 95-001-109910

3.4 The COB account belonging to Leumi Bank 95-001-108810

3.5 The FOB account belonging to Hapoalim Bank 95-001-129912

3.6 The COB account belonging to Hapoalim Bank 95-001-128812

3.7 The FOB account belonging to Union Bank 95-001-139913

3.8 The COB account belonging to Union Bank 95-001-138813

3.9 The FOB account belonging to First International Bank 95-001-319931

3.10 The COB account belonging to First International Bank 95-001-318831

3.11 The FOB account belonging to RB itself 95-001-959995

3.12 The COB account belonging to RB itself 95-001-958895

In principle, the FOB accounts and the COB accounts can also be managed at any financial institution that is acceptable to the COB/FOB and to the RB, including in the COB/FOB itself, provided that the RB will be allowed to act in them. Furthermore, any bank is likely to define several COB/FOB accounts, such as, for example, for any type of deposit or any type of credit—again in order to facilitate accounting auditing.

Event 1:

On Oct. 1, 2003, Mr. Cohen joined the closed banking program of the RB, signed a debit authorization for his two accounts and received a login number: 28730666. It is appreciated that “account” as used in this example may refer to a user account (or login) and not necessarily to a banking account. FIG. 4A shows details of Mr. Cohen's user account at the RB, as at Oct. 15, 2003.

Event 2:

On Nov. 1, 2003, Mr. Cohen entered his user account into the system and sought to deposit NIS 100,000 by debiting his source account at the Leumi Bank. From the list of suggested banks and deposits, Mr. Cohen chose a one-time deposit for one year at certain additional terms offered by the Discount Bank (Bank Code 11). The following are the fund transfer orders that the RB initiated following the event and according to the value date of Nov. 1, 2003:

| | | |
|---|---|---|
| To debit: | 10-600-123456 | NIS 100,000 |
| To credit: | 95-001-111111 | NIS 100,000 |

(Via the inter-bank clearing house based on the account debit authorization.)

Technically, the debit is presented by the clearing house to the transit account of the Leumi Bank and from there it “rolls on” to the client account, but what is important is the bottom line in the screening of the technical transit accounts and therefore the order is shown thus.

| | | |
|---|---|---|
| To debit: | 95-001-111111 | NIS 100,000 |
| To credit: | 95-001-119911 | NIS 100,000 |

(Via internal back-office procedures).

FIG. 4B shows details of Mr. Cohen's user account at the RB as at Nov. 2, 2003:

Event 3:

On Nov. 21, 2003, Mr. Cohen instructed the system to deposit NIS 1,000, by debiting his source account at the Leumi Bank, in an interest-bearing deposit (we shall assume that it accumulates to the principal at the end of each month), which can mature on a daily basis, unlimited in time, offered by the Union Bank (Bank Code13). The following are the fund transfer orders initiated by the RB following the event and according to the value date of Nov. 2, 2003:

| | | |
|---|---|---|
| To debit: | 10-600-123456 | NIS 1,000 |
| To credit: | 95-001-111111 | NIS 1,000 |

(Via the inter-bank clearing house based on the account debit authorization.)

| | | |
|---|---|---|
| To debit: | 95-001-111111 | NIS 1,000 |
| To credit: | 95-001-139913 | NIS 1,000 |

(Via internal back-office procedures).

FIG. 4C shows details of Mr. Cohen's user account at the RB as at Nov. 2, 2003:

Event 4:

On Dec. 3, 2003, Mr. Cohen instructed the system to transfer an additional NIS 5,000 to the deposit at the Union Bank as well as to transfer NIS 2,000 on the 28^{th} day of each month into a deposit, in monthly deposits for the period of 24 months, at certain terms offered by the Hapoalim Bank. Mr. Cohen requested that the deposit to the latter deposit be done from the source account at the Mizrahi Bank. The following are the fund transfer orders initiated by the RB subsequent to the event and according to a value date of Dec. 3, 2003:

| | | |
|---|---|---|
| To debit: | 10-600-123456 | NIS 5,000 |
| To credit: | 95-001-111111 | NIS 5,000 |

(Via the inter-bank clearing house based on the account debit authorization.)

| | | |
|---|---|---|
| To debit: | 95-001-111111 | NIS 5,000 |
| To credit: | 95-001-139913 | NIS 5,000 |

(Via internal back-office procedures).

The following are the fund transfer orders initiated by the RB subsequent to the event and according to a value date of Dec. 28, 2003, Jan. 28, 2004, Feb. 28, 2004, and so forth:

| | | |
|---|---|---|
| To debit: | 20-461-654321 | NIS 2,000 |
| To credit: | 95-001-111111 | NIS 2,000 |

(Via the inter-bank clearing house based on the account debit authorization.)

| | | |
|---|---|---|
| To debit: | 95-001-111111 | NIS 2,000 |
| To credit: | 95-001-129912 | NIS 2,000 |

(Via internal back-office procedures).

FIG. 4D shows details of Mr. Cohen's user account at the RB as at Mar. 2, 2004:

Event 5:

On Mar. 2, 2004, the Mizrahi Bank decided to return the debit in the sum of NIS 2,000 dated Feb. 28, 2004, due to insufficient funds. The following are details of the fund transfer order subsequently created (value date of Feb. 28, 2004):

| | | |
|---|---|---|
| To debit: | 95-001-111111 | NIS 2,000 |
| To credit: | 20-461-654321 | NIS 2,000 |

(Via the inter-bank clearing house based on the account debit authorization.) Following the recording of the return, the RB initiated the fund transfer order:

| | | |
|---|---|---|
| To debit: | 95-001-129912 | NIS 2,000 |
| To credit: | 95-001-111111 | NIS 2,000 |

(Via internal back-office procedures).

FIG. 4E shows details of Mr. Cohen's user account at the RB as at Mar. 3, 2004.

It may be assumed, for the purpose of the example, that subsequent to the return, the automatic standing recurrent order for the deposit was terminated. However, the client was able to continue to transact within the system.

Event 6:

On Mar. 20, 2004, Mr. Cohen instructs the system to repay the entire balance of the Deposit 543771 held at the Union Bank (bank code 13). The following are the fund transfer orders initiated by the RB subsequent to the event and according to the value date of Mar. 20, 2004:

| | | |
|---|---|---|
| To debit: | 95-001-111111 | NIS 6,090.10 |
| To credit: | 10-600-123456 | NIS 6,090.10 |

(Via the inter-bank clearing house based on the account debit authorization.)

| | | |
|---|---|---|
| To debit: | 95-001-139913 | NIS 6,090.10 |
| To credit: | 95-001-111111 | NIS 6,090.10 |

(Via internal back-office procedures).

FIG. 4F shows details of Mr. Cohen's user account at the RB as at Mar. 21, 2004:

Event 7:

On May 13, 2004, Mr. Cohen asks for credit (collateralized loan) in the sum of NIS 90,000. Since he has a deposit with the sum of the principal of NIS 100,000, which serves as collateral, herein referred to as a “set-off” or “setting-off”, the system shows that there are many banks interested in issuing him the requested credit. Mr. Cohen chooses the credit at certain interest terms offered by the First International Bank (bank code 31) having the right to partial or full repayment of the principal at any time. The balance of the credit, which has not yet been paid, including all of the accumulated interest, shall be paid by setting-off from Deposit 526464 which is to be repaid on Nov. 1, 2004. The following are the fund transfer orders initiated by the RB subsequent to the event and according to the value date of May 13, 2004:

| | | |
|---|---|---|
| To debit: | 95-001-111111 | NIS 90,000 |
| To credit: | 10-600-123456 | NIS 90,000 |

(Via the inter-bank clearing house based on the account debit authorization.)

| | | |
|---|---|---|
| To debit: | 95-001-318831 | NIS 90,000 |
| To credit: | 95-001-111111 | NIS 90,000 |

(Via internal back-office procedures).

FIGS. 4G and 4H, taken together, show details of Mr. Cohen's user account at the RB as at May 14, 2004.

Event 8:

On Jul. 20, 2004, Mr. Cohen gives an order to repay NIS 20,000 from the principal of the loan. The following are the fund transfer orders initiated by the RB subsequent to the event:

| | | |
|---|---|---|
| To debit: | 10-600-123456 | NIS 20,000 |
| To credit: | 95-001-111111 | NIS 20,000 |

(Via the inter-bank clearing house based on the account debit authorization.)

| | | |
|---|---|---|
| To debit: | 95-001-111111 | NIS 20,000 |
| To credit: | 95-001-318831 | NIS 20,000 |

(Via internal back-office procedures).

FIGS. 4I and 4J, taken together, show details of Mr. Cohen's user account at the RB as at Jul. 21, 2004.

Event 9:

Two days after issuing the payment order (Jul. 22, 2004), the Leumi Bank refuses the debit and returns it. The following is the fund transfer order created subsequent to the return of the debit (value date of Jul. 20, 2004):

| | | |
|---|---|---|
| To debit: | 95-001-111111 | NIS 20,000 |
| To credit: | 10-600-123456 | NIS 20,000 |

(Via the inter-bank clearing house based on the account debit authorization.)

Following the recording of the return, the RB initiates the fund transfer order according to the value date of Jul. 20, 2004:

| | | |
|---|---|---|
| To debit: | 95-001-318831 | NIS 20,000 |
| To credit: | 95-001-111111 | NIS 20,000 |

(Via internal back-office procedures).

FIGS. 4K and 4L, taken together, show details of Mr. Cohen's user account at the RB as at Jul. 23, 2004.

Event 10:

On Nov. 1, 2004, Deposit 526464 terminates, with the sum of the deposit, principal and interest being NIS 110,000. The balance of credit 746523, which was issued against the set-off of the deposit is NIS 90,000 principal and NIS 5,059.70 interest, a total of NIS 95,059.70. The following are the fund transfer orders that the RB initiates subsequent to the event:

| | | |
|---|---|---|
| To debit: | 95-001-119911 | NIS 110,000 |
| To credit: | 95-001-111111 | NIS 110,000 |

(Via internal back-office procedures).

| | | |
|---|---|---|
| To debit: | 95-001-111111 | NIS 95,059.70 |
| To credit: | 95-001-318831 | NIS 95,059.70 |

(Via internal back-office procedures).

| | | |
|---|---|---|
| To debit: | 95-001-111111 | NIS 14,940.30 |
| To credit: | 10-600-123456 | NIS 14,940.30 |

(Via the inter-bank clearing house based on the account debit authorization.)

FIGS. 4M and 4N, taken together, show details of Mr. Cohen's user account at the RB as at Nov. 2, 2004.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A banking method comprising:
receiving an authorization from a customer to transfer funds belonging to said customer from a source financial institution as part of a closed banking transaction, wherein said receiving step comprises receiving said authorization separate from any instruction to transfer funds;
providing at least one closed banking deposit option to said customer via a communications device for selection thereat;
receiving a deposit option selection from said communications device; and
transferring funds from said source financial institution in accordance with said deposit option selection, wherein said transferring step comprises effecting said transfer via an interbank clearing entity without requiring a specific approval from said source financial institution for said transfer.

2. A method according to claim 1 wherein said receiving an authorization step comprises recruiting said customer to a closed banking program.

3. A method according to claim 1 wherein said receiving an authorization step comprises receiving an authorization from said customer to transfer funds belonging to said customer from at least one account in said source financial institution.

4. A method according to claim 1 wherein said transferring step comprises transferring said funds to a receiving bank for deposit therein.

5. A method according to claim 4 wherein said providing step comprises providing said deposit option for a funds deposit in said receiving bank.

6. A method according to claim 1 wherein said transferring step comprises:
transferring said funds to a receiving bank;
said receiving bank distributing at least a portion of said funds to at least one bank other than said receiving bank for deposit therein.

7. A method according to claim 6 wherein said providing step comprises providing at least one deposit option for a funds deposit in at least one bank other than said receiving bank.

8. A method according to claim 1 and further comprising transferring said transferred funds back to said source financial institution after a predefined period of time.

9. A method according to claim 1 wherein any of said providing and receiving steps are performed by a non-banking concern.

10. A method according to claim 1 wherein any of said providing and receiving steps are performed by a cellular telephone service provider.

11. A method according to claim 1 wherein any of said providing and receiving steps are performed by a cable television provider.

12. A method according to claim 1 wherein any of said providing and receiving steps are performed by a satellite television provider.

13. A method according to claim 1 wherein said providing step comprises indicating a funds transfer amount via said deposit option.

14. A method according to claim 1 wherein said providing step comprises indicating an interest rate amount via said deposit option.

15. A method according to claim 1 and further comprising soliciting said customer to provide said authorization.

16. A method according to claim 1 wherein said providing step comprises providing via any of an IVR menu, a WAP menu, an SMS men, an HTML-based menu, and an XML-based menu.

17. A method according to claim 1 wherein said receiving a deposit option selection step comprises receiving via any of an IVR interface, an SMS interface, a WAP interface, an HTML interface, and an XML interface.

18. A closed banking marketing method comprising:
soliciting at least one customer of a source financial institution to use closed banking depository services offered by a financial institution; and
causing said customer to effect a legal agreement with said financial institution authorizing the debiting of said customer's deposit account at a source financial institution,
wherein any of said soliciting and causing steps is performed by a recruiting agent being a non-banking entity.

19. A banking method comprising:
soliciting at least one customer of a source financial institution to use closed banking depository services offered by another financial institution;
causing said customer to effect a legal agreement with said other financial institution authorizing the debiting of said customer's deposit account at said source financial institution, wherein any of said soliciting and causing steps is performed by a recruiting agent being a non-banking entity;
providing at least one closed banking deposit option to said customer via a communications device for selection thereat;
receiving a deposit option selection from said communications device; and
transferring funds from said source financial institution to said other financial institution in accordance with said deposit option selection, wherein said transferring step comprises effecting said transfer via an interbank clearing entity without requiring a specific approval from said source financial institution for said transfer.

20. A method according to claim 19 wherein said causing step comprises receiving an authorization from said customer to transfer funds belonging to said customer from at least one account in said source financial institution.

21. A method according to claim 19 wherein said transferring step comprises transferring said funds to a receiving bank for deposit therein.

22. A method according to claim 21 wherein said providing step comprises providing said deposit option for a funds deposit in said receiving bank.

23. A method according to claim 19 wherein said transferring step comprises:
transferring said funds to a receiving bank;
said receiving bank distributing at least a portion of said funds to at least one bank other than said receiving bank for deposit therein.

24. A method according to claim 23 wherein said providing step comprises providing at least one deposit option for a funds deposit in at least one bank other than said receiving bank.

25. A method according to claim 19 and further comprising transferring said transferred funds back to said source financial institution after a predefined period of time.

26. A method according to claim 19 wherein any of said soliciting, causing, providing and receiving steps are performed by a non-banking concern.

27. A method according to claim 19 wherein any of said soliciting, causing, providing and receiving steps are performed by a cellular telephone service provider.

28. A method according to claim 19 wherein any of said soliciting, causing, providing and receiving steps are performed by a cable television provider.

29. A method according to claim 19 wherein any of said soliciting, causing, providing and receiving steps are performed by a satellite television provider.

30. A method according to claim 19 wherein said providing step comprises indicating a funds transfer amount via said deposit option.

31. A method according to claim 19 wherein said providing step comprises indicating an interest rate amount via said deposit option.

32. A method according to claim 19 wherein said providing step comprises providing via any of an IVR menu, a WAP menu, an SMS men, an HTML-based menu, and an XML-based menu.

33. A method according to claim 19 wherein said receiving a deposit option selection step comprises receiving via any of an IVR interface, an SMS interface, a WAP interface, an HTML interface, and an XML interface.

34. A banking method comprising:
providing at least one closed banking credit option to a closed banking customer via a communications device for selection thereat;
receiving a credit option selection from said communications device;
collateralizing a credit amount indicated by said credit option selection with at least one closed banking deposit transferred by said customer from said customer's account at said source financial institution; and
transferring at least a portion of said credit amount from at least one credit offering bank to said customer's account at said source financial institution.

35. A method according to claim 34 and further comprising approving said credit if said customer has sufficient closed banking deposits and for a sufficient deposit period such that they may be used as collateral for said credit.

36. A method according to claim 34 and further comprising approving said credit where the amount of said credit that is to be transferred into said customer's account at said source financial institution satisfies a function of the amount of said deposits that originated from said account.

37. A method according to claim 34 and further comprising transferring at least a portion of said collateral deposit to said credit offering bank after the expiration of the deposit period of said collateral deposit

38. A method according to claim 34 and further comprising:
transferring a credit repayment amount from said customer's account at said source financial institution to said credit offering bank responsive to a credit repayment instruction from said customer; and
reducing said credit amount by said credit repayment amount.

39. A banking system comprising:
means for receiving an authorization from a customer to transfer funds belonging to said customer from a source financial institution as part of a closed banking transaction, wherein said means for receiving is operative to receive said authorization separate from any instruction to transfer funds;
means for providing at least one closed banking deposit option to said customer via a communications device for selection thereat;
means for receiving a deposit option selection from said communications device; and
means for transferring funds from said source financial institution in accordance with said deposit option selection, wherein said means for transferring is operative to effect said transfer via an interbank clearing entity without requiring a specific approval from said source financial institution for said transfer.

40. A system according to claim 39 wherein said means for receiving an authorization is operative to receive an authorization is operative to recruit said customer to a closed banking program.

41. A system according to claim 39 wherein said means for receiving an authorization is operative to receive an authorization from said customer to transfer funds belonging to said customer from at least one account in said source financial institution.

42. A system according to claim 39 wherein said means for transferring is operative to transfer said funds to a receiving bank for deposit therein.

43. A system according to claim 42 wherein said means for providing is operative to provide said deposit option for a funds deposit in said receiving bank.

44. A system according to claim 39 wherein said means for transferring is operative to:
transfer said funds to a receiving bank,
wherein said receiving bank is operative to distribute at least a portion of said funds to at least one bank other than said receiving bank for deposit therein.

45. A system according to claim 44 wherein said means for providing is operative to provide at least one deposit option for a funds deposit in at least one bank other than said receiving bank.

46. A system according to claim 39 and further comprising means for transferring said transferred funds back to said source financial institution after a predefined period of time.

47. A system according to claim 39 wherein any of said means for providing and receiving are embodied in a non-banking concern.

48. A system according to claim 39 wherein any of said means for providing and receiving are embodied in a cellular telephone service provider.

49. A system according to claim 39 wherein any of said means for providing and receiving are embodied in a cable television provider.

50. A system according to claim 39 wherein any of said means for providing and receiving are embodied in a satellite television provider.

51. A system according to claim 39 wherein said means for providing is operative to indicate a funds transfer amount via said deposit option.

52. A system according to claim 39 wherein said means for providing is operative to indicate an interest rate amount via said deposit option.

53. A system according to claim 39 and further comprising means for soliciting said customer to provide said authorization.

54. A system according to claim 39 wherein said means for providing is operative to provide via any of an IVR menu, a WAP menu, an SMS men, an HTML-based menu, and an XML-based menu.

55. A system according to claim 39 wherein said means for receiving a deposit option selection is operative to receive via any of an IVR interface, an SMS interface, a WAP interface, an HTML interface, and an XML interface.

56. A closed banking marketing system comprising:
means for soliciting at least one customer of a source financial institution to use closed banking depository services offered by a financial institution; and
means for causing said customer to effect a legal agreement with said financial institution authorizing the debiting of said customer's deposit account at a source financial institution,
wherein any of said means for soliciting and causing are embodied in a recruiting agent being a non-banking entity.

57. A banking system comprising:
means for soliciting at least one customer of a source financial institution to use closed banking depository services offered by another financial institution;
means for causing said customer to effect a legal agreement with said other financial institution authorizing the debiting of said customer's deposit account at said source financial institution, wherein any of said means for soliciting and causing are embodied in a recruiting agent being a non-banking entity;
means for providing at least one closed banking deposit option to said customer via a communications device for selection thereat;
means for receiving a deposit option selection from said communications device; and
means for transferring funds from said source financial institution to said other financial institution in accordance with said deposit option selection, wherein said means for transferring is operative to effect said transfer via an interbank clearing entity without requiring a specific approval from said source financial institution for said transfer.

58. A system according to claim 57 wherein said means for causing is operative to receive an authorization from said customer to transfer funds belonging to said customer from at least one account in said source financial institution.

59. A system according to claim 57 wherein said means for transferring is operative to transfer said funds to a receiving bank for deposit therein.

60. A system according to claim 59 wherein said means for providing is operative to provide said deposit option for a funds deposit in said receiving bank.

61. A system according to claim 57 wherein said means for transferring is operative to:
transfer said funds to a receiving bank,
wherein said receiving bank is operative to distribute at least a portion of said funds to at least one bank other than said receiving bank for deposit therein.

62. A system according to claim 61 wherein said means for providing is operative to provide at least one deposit option for a funds deposit in at least one bank other than said receiving bank.

63. A system according to claim 57 and further comprising means for transferring said transferred funds back to said source financial institution after a predefined period of time.

64. A system according to claim 57 wherein any of said means for soliciting, causing, providing and receiving are embodied in a non-banking concern.

65. A system according to claim 57 wherein any of said means for soliciting, causing, providing and receiving are embodied in a cellular telephone service provider.

66. A system according to claim 57 wherein any of said means for soliciting, causing, providing and receiving are embodied in a cable television provider.

67. A system according to claim 57 wherein any of said means for soliciting, causing, providing and receiving are embodied in a satellite television provider.

68. A system according to claim 57 wherein said means for providing is operative to indicate a funds transfer amount via said deposit option.

69. A system according to claim 57 wherein said means for providing is operative to indicate an interest rate amount via said deposit option.

70. A system according to claim 57 wherein said means for providing is operative to provide via any of an IVR menu, a WAP menu, an SMS men, an HTML-based menu, and an XML-based menu.

71. A system according to claim 57 wherein said means for receiving a deposit option selection is operative to receive via any of an IVR interface, an SMS interface, a WAP interface, an HTML interface, and an XML interface.

72. A banking system comprising:
means for providing at least one closed banking credit option to a closed banking customer via a communications device for selection thereat;
means for receiving a credit option selection from said communications device;
means for collateralizing a credit amount indicated by said credit option selection with at least one closed banking deposit transferred by said customer from said customer's account at said source financial institution; and
means for transferring at least a portion of said credit amount from at least one credit offering bank to said customer's account at said source financial institution.

73. A system according to claim 72 and further comprising means for approving said credit if said customer has sufficient closed banking deposits and for a sufficient deposit period such that they may be used as collateral for said credit.

74. A system according to claim 72 and further comprising means for approving said credit where the amount of said credit that is to be transferred into said customer's account at said source financial institution satisfies a function of the amount of said deposits that originated from said account.

75. A system according to claim 72 and further comprising means for transferring at least a portion of said collateral deposit to said credit offering bank after the expiration of the deposit period of said collateral deposit

76. A system according to claim 72 and further comprising:
means for transferring a credit repayment amount from said customer's account at said source financial institution to said credit offering bank responsive to a credit repayment instruction from said customer; and
means for reducing said credit amount by said credit repayment amount.
